(19) United States
(12) Patent Application Publication
(10) Pub. No.: US 2011/0085456 A1
(43) Pub. Date: Apr. 14, 2011

(54) Signal Egress Alarm

(76) Inventor: Dennis A. Zimmerman, Bridgewater, VA (US)

(21) Appl. No.: 12/578,942

(22) Filed: Oct. 14, 2009

(51) Int. Cl. H04L 12/26

(52) U.S. Cl. 370/252

(57) ABSTRACT

Notification of a detected potential egress signal from a Broadband Communications System (BCS) is expedited by detection of signal Strength at a mobile detector which is above a user-specified threshold. When a potential egress signal having a strength above a user-specified threshold is detected, it is reported with other, lesser strength egress signals, immediately over a wireless link to a central server which is dedicated to a given BCS or which provides a notification service to a plurality of such systems. The central server may provide additional processing such as for authenticating a detected signal as an egress signal and/or estimating egress signal strength at a shielding flaw and, responsive to a detected signal having a signal strength above the user-specified threshold, sending notifications of the signal egress detection or shielding flaw a user-specified number of times at user-specified intervals while the signal egress persists or until earlier terminated.

### FIELD OF THE INVENTION

The present invention generally relates to the operation and maintenance of Broadband Communications Systems and, more particularly, to the detection and prioritization of repair of points of strong signal egress from a Broadband Communication System.

### BACKGROUND OF THE INVENTION

Installation and use of Broadband Communication Systems (BCSs) has become widespread and services provided by such systems have increased from distribution of entertainment programming (as in Community Antenna Television (CATV) predecessor systems) to high-speed data network access and digital telephony such as Voice over Internet Protocol (VoIP) systems. Broadband signals sufficient to carry such a high volume of data traffic is only possible consistent with free-space communications such as radio signaling (e.g. broadcast signals, air traffic control communication signals, navigation communication signals, wireless telephony signals and the like) because the signals carried by the Broadband Communication System are confined by use of shielded cables as well as being shielded from interference from broadcast or other free-space communications signals. However, such shielded cable is subject to both damage and deterioration over time and will develop points at which the shielding integrity is compromised; effectively forming an antenna and allowing the symmetrical effects of signal ingress and egress.

Signal ingress of a broadcast signal may cause interference effects in the Broadband Communication System and thus reduce the quality of signals communicated therethrough by superposition of generally narrow bandwidth broadcast and low amplitude signals thereon. Signal egress, however, essentially broadcasts broadband signals into the free-space environment, potentially at a relatively high level which can cause significant interference with other and possibly critical narrow band communications such as the aircraft communications and navigation frequency band (108 MHz through 136 MHz).

Therefore, it is extremely important that any compromise of shielding integrity in Broadcast Communication Systems be repaired or otherwise remedied as quickly as possible since, at best, even small cable shielding integrity flaws may compromise the quality of service provided by the Broadband Communications System while, at worst, major signal egress can potentially compromise public safety. For that reason, operators of Broadband Communications Signals generally maintain substantial facilities, equipment and staff available to perform repairs on a continuing basis. Moreover, it is the general practice that vehicles for transporting equipment and personnel to work sites to conduct installations, upgrades and repairs will include equipment for detecting egress signals along their travel routes, possibly detecting approximate locations thereof using a global positioning system (GPS). Detection of egress signals may then be recorded or transmitted to a central facility (e.g. a distribution center or hub for the Broadband Communication System or a facility providing signal egress reporting for a plurality of Broadband Communications Systems as a service) so that repair personnel and equipment can be dispatched. Since work sites will be substantially randomly distributed locations over an area necessarily coextensive with the service area of the Broadband Communications System and broadband signal transmission cable will generally be installed along roadways, signal egress detection during travel to work sites will, on average, cover the entire service area on a near daily basis and thus effectively provide frequent and relatively close range inspection of the entire Broadband Communications System. However, detection of signal egress in this manner, while usually capable of recording egress signal strength, does not prioritize reportage of detected signal egress. Rather, known system usually store detections of signal egress and download the data corresponding to the detections when the repair personnel and equipment return to the BCS maintenance facility after at least nominally completing work for which they were dispatched.

### SUMMARY OF THE INVENTION

It is therefore an object of the present invention to provide a prioritized and expedited signal egress reporting system with immediate reportage of signal egress above a threshold signal strength.

It is another object of the invention to provide continued close monitoring and reportage of signal egress above a predetermined threshold signal strength until fully effective repairs have been performed.

It is a further object of the invention to provide BCS administrators, maintenance supervisors or other responsible personnel with a tool to control and limit the duration of a seriously over-limit egress of signal from the BCS and to thereby avoid potential licensed service interference.

In order to accomplish these and other objects of the invention, a system and method for detecting and expediting reportage of detection of egress signals from a Broadband Communications System having a signal strength above a user-specified threshold is provided which includes steps or apparatus for capturing time, location and signal strength upon detection of a potential egress signal, comparing the detected signal strength with a user-specified threshold signal strength, transmitting the captured time, location and signal strength to a central server when said signal strength exceeds said user-specified threshold, and transmitting a notification of an over-limit egress signal a user-specified number of times at user-specified intervals while signal egress persists unless earlier terminated.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high-level overview of the architecture of the invention,

FIG. 2 is a flow chart depicting a preferred process for discriminating over-limit egress signals and expediting reportage, and

FIG. 3 is a flow chart depicting a preferred process for determining and executing notifications of over-limit signals.

### DETAILED DESCRIPTION OF A PREFERRED EMBODIMENT OF THE INVENTION

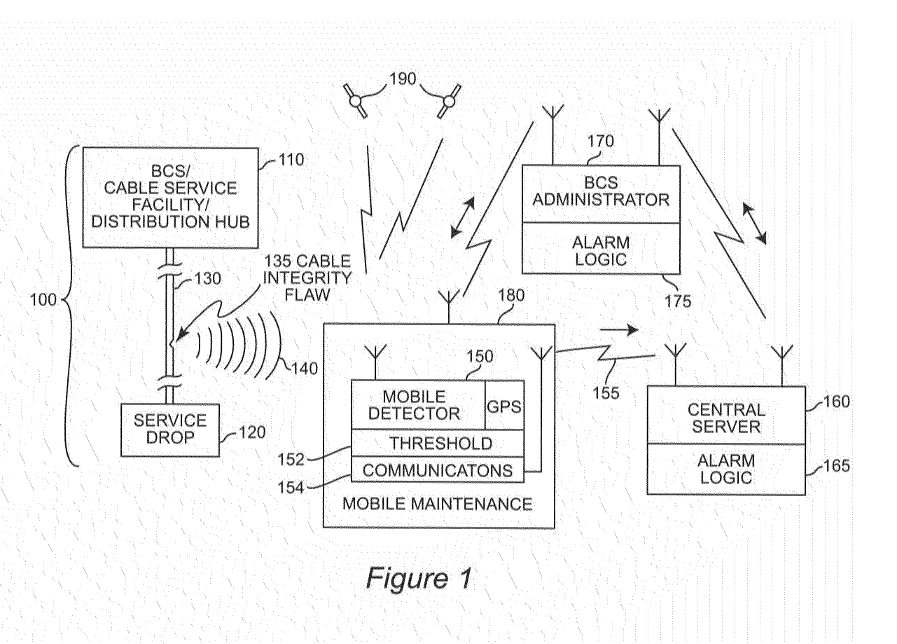

Referring now to the drawings, and more particularly to FIG. 1, there is shown a high-level overview of the architecture of the invention. It should be understood that this depiction and the terminology used below to describe it is arranged to be largely generic to several possible embodiments or implementations of the invention. For example, the preferred implementation and embodiment of the invention provide for implementation on a central server at a facility which may provide high signal strength egress reporting as a service to a plurality of Broadband Communication Systems regionally, nationally or globally. On the other hand, the invention could be implemented in a manner where the central server is a dedicated server for a single BCS. In this regard, it is also to be understood that wireless communication links depicted in FIG. 1 are preferred but exemplary of communication links that are not limited to wireless telephony, Wi-Fi, MyFi, Wi-Max, radio or the like but could even be hardwired or a conventional wired communications link, particularly if the central server and the BCS administrator (and possibly the BCS central facility or a communication hub thereof) are substantially co-located either logically or geographically.

In FIG. 1, the BCS 100 is depicted in a highly schematic and much simplified manner as comprising a BCS or cable service facility 110 which can be a central facility, distribution hub or the like which services at least a portion of the BCS, and an exemplary cable/service drop 120 such as one of many residential cable drops serviced by the BCS which are connected by a shielded broadband transmission cable 130. The shielded cable 130 is depicted as having a significant shielding flaw which essentially forms an antenna that broadcasts broadband signals into free-space as depicted at 140. A mobile maintenance vehicle and personnel are schematically depicted at 180 which includes a mobile detector 150 which may also include a global positioning system (GPS) capability based on triangulation of signals from GPS satellites 190, details of which are unimportant to an understanding of the invention. The mobile detector 150 will thus have the capability of not only detecting signal egress but the signal strength of the egress signal and the location of the mobile detector 150 when the detection is made. The detection may be made by a number of known methods, the simplest of which is by center frequency and which is entirely adequate to the successful practice of the invention.

In accordance with the invention, mobile detector 150 also includes at least a threshold comparator 152, preferably including further processing to compute an approximation of the egress signal strength at the location of the cable integrity flaw 135 as may be done from observance of the signal strength at several locations (measurements are generally performed once per second in accordance with GPS location reports but may be done more frequently if desired, particularly following an initial detection) and determining the location of the cable integrity flaw 135 based on signal strength and calculated proximity to the cable 130 at each report point (e.g. by resolving location by analysis of multi-path interference patterns as in U.S. Pat. No. 6,833,859 to Schneider et al. or elimination of duplicative detections from plural locations as disclosed in U.S. patent application Ser. No. 12/109,404, both assigned to the assignee of the present invention and hereby fully incorporated by reference) then computing the signal strength at the flaw from the signal strength actually detected since signal strength diminishes with the square of the distance from the source. This detection may also be coordinated with egress signal detection from other mobile detectors; a preferred technique for doing so as well as estimating signal strength at the source from one or more mobile detectors is disclosed in the above-incorporated U.S. patent application Ser. No. 12/109,404. However, this technique, while preferred, is also not critical to the practice of the invention since all that is required is to discriminate cable integrity flaws causing a signal egress strength likely to cause interference with free-space communications. As a practical matter, it will usually be desirable for the threshold to be set at a much lower level to be certain that all egress signals which could possibly cause such interference will be detected based on a maximum or average distance of a mobile detector from the nearest cable 130.

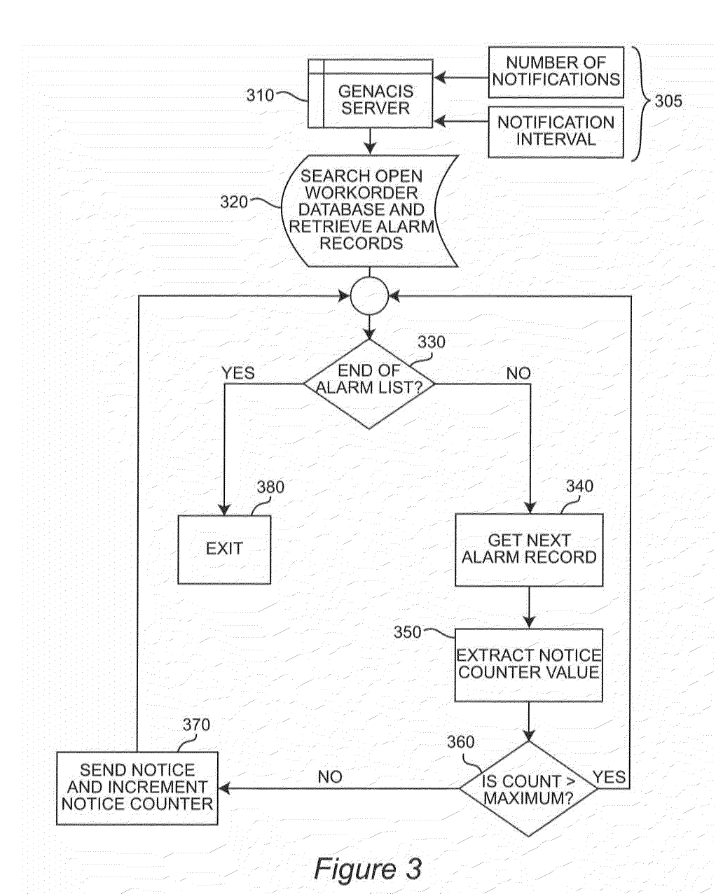

When an egress signal having a signal strength above a threshold which may be set as desired is detected, a communications element/arrangement 145 transmits a signal 155 preferably including information including time and location of detection and detected signal strength as well as a digitized sample of the detected signal, to a central server 16 by means of wireless telephony, Wi-Fi, MyFi, Wi-Max or the like. The medium of such a communication link is unimportant to the practice of the invention. Any of these or similar systems are capable of sending a communication to any arbitrary location such as the preferred central server at a facility for providing the capabilities of the invention as a service. On the other hand, if the central server 160 is dedicated to a single BCS or portion thereof, other shorter range communications links could be used such as citizens band radio or the like. The central server 160 may or may not include alarm logic 165 as will be discussed more fully below with reference to FIG. 3.

It should be understood that detection of an over-limit egress signal can simply be digitized and, without any further analysis, be immediately transmitted with other, more normal detection events, accumulated in a queue, to the central server 160. Alternatively, more complex analysis may be performed in the mobile detector such as that described in the above-incorporated patent or patent application. The advantage of the latter alternative of more complex analysis is that reportage of detected egress signals that may only be over-limit if remote from the mobile detector 150 may be accumulated with normal events over a timed period. Since, in certain protocols, the header information is relatively large and can exceed the size of the corresponding “payload” or useful data in a communicated signal packet, immediate reportage of detections of egress signals that may not, in fact, be over-limit leads to substantial throughput inefficiency of communication. If more complex analysis is performed at the mobile detector, emptying of the accumulated data in the data queue only at timed intervals or when a clearly over-limit egress signal is detected provides more efficient communication without significant delay of reportage of detection of possibly but not necessarily over-limit egress signals when the timed interval is set to insure reasonable efficiency of communication consistent with rate of detection of more normal events and is preferred for that reason for certain communication protocols. If protocols requiring less voluminous headers are used, there is little, if any, advantage in using more complex analysis in the mobile detector other than to determine the actual peak signal strength (e.g. by filtering as described in the above incorporated patent application) and thereby reduce the number of immediate transmissions if the detection threshold for discriminating an over-limit egress signal is set too low.

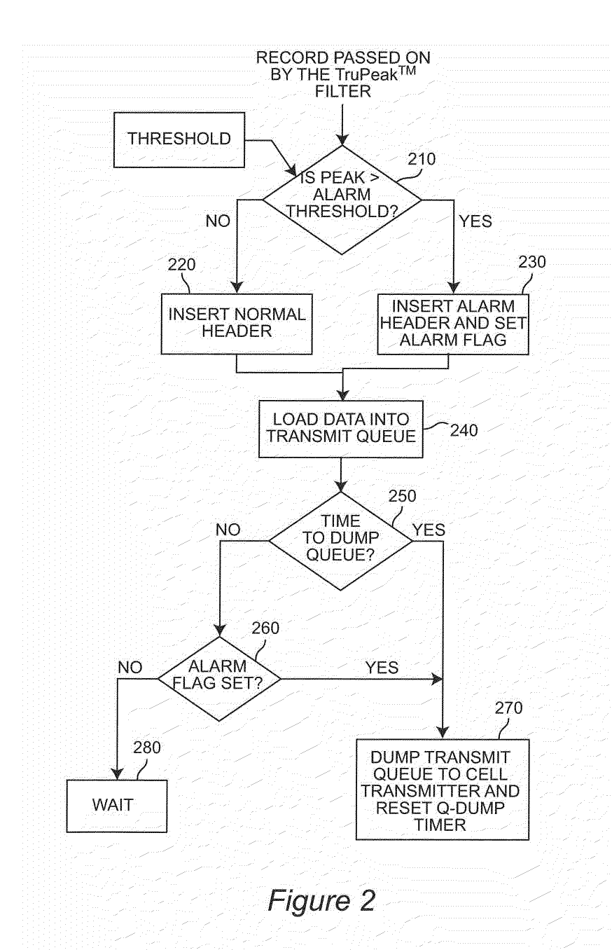

Referring again to FIG. 1, when a transmission 155 from a mobile detector 150 is received at the central server 160, the detection location and signal strength may be further analyzed to determine if any detection events reflect an over-limit signal egress as will be described in greater detail below with reference to FIG. 2. If detection of an over-limit egress signal is confirmed (e.g. by confirming the digitized detected signal and detection time is, in fact, a signal being communicated by the BCS and that the signal strength is above a freely established threshold) alarm logic 165 is invoked to control communications of one or more messages regarding the over-limit egress signal condition to the BCS administrator or other responsible BCS management personnel 170 (which may be referred to collectively hereinafter simply as BCS administrator). This communication is preferably performed by e-mail, text messaging, wired or wireless telephony remote control of an alarm, or the like or any combination thereof as may be preferred by the BCS administrator and/or other responsible personnel. Upon receipt of such communications, additional alarm logic 175 supplementary to alarm logic 165 may be invoked (e.g. for repetition and/or distribution of the message) but is not required. The BCS administrator can then manually or automatically dispatch personnel and equipment to remediate the shielding flaw 135. It should be noted that, in general, alarm logic 175 will be principally directed to determining the number of times and frequency or interval of notifications of an over-limit signal egress detection and corresponding shielding flaw which will prompt the administrator or other responsible personnel to accord additional and increasing priority to the repair of the flaw as the notification is repeated. The communication between the BCS administrator 170 and central server is depicted as being bi-directional to allow such personalization to be communicated to alarm logic 165 if such functions are to be controlled at the central server. Communication from the BCS administrator to the central server 160 preferably includes the desired threshold signal strength for discriminating a detection to be over-limit, and when a repair of the shielding flaw has been nominally effected so that another detection will be handled by the central server as a new detection with numbers and frequency of notifications reset to initial values. A time interval for reporting accumulated detections can be similarly set at the will of the BCS administrator in either or both of the central server and one or more mobile detectors 150.

Referring now to FIG. 2, the preferred methodology of discrimination and control of reportage by the mobile detector will be discussed. As alluded to above, some of the functionality illustrated in FIGS. 2 and 3 may be divided between the central server 160 and alarm logic 165, the mobile detector 150 and the BCS administrator 170 and alarm logic 175, if provided. Alternatively, two or more of these elements may perform the illustrated functionalities redundantly or in complementary manners.

Assuming that a desired threshold for discriminating an over-limit egress signal strength has been specified, it is first determined at step 210 whether of not the threshold is exceeded by a particular signal that has been detected. This step could be performed in the mobile detector 150 if the desired threshold for the BCS has been communicated thereto. Alternatively or complementarily, this step or a portion thereof can be and preferably is performed in the central server 160 which can both authenticate the signal as an egress signal and, preferably, project the signal strength peak from a plurality of detections by one mobile detector or from different mobile detectors.

If the detected signal does not exceed the over-limit threshold, a normal header is applied in accordance with the protocol being used for communication either between the mobile detector 150 and the central server 160 or the central server 160 and BCS administrator 170, as illustrated at 220. If, however, the detected or computed signal strength is above the specified over-limit threshold, the same action is taken to provide an appropriate alarm header and, additionally an over-limit flag is set as illustrated at 230. In either case, the data including the applied header(s) is loaded into a transmit queue as illustrated at 240.

Then, as depicted at 250, it is determined whether or not the data accumulated in step 240 is to be transmitted either from the mobile detector 150 to the central server 160 and/or from the central server 160 to the corresponding BCS administrator 170. If the specified time interval for periodic data transmissions has elapsed, the process proceeds directly to step 270 where the data queue is emptied, the previously accumulated data transmitted and the timer reset. However, if the specified time interval has not elapsed, the accumulated data or the data queue, depending on where the over-limit flag is located (which is irrelevant to the successful practice of the invention), is checked to determine if the over-limit flag has been set as illustrated at 260. If not, the process enters a wait state which may be visualized as looping back to step 210 but taking no further action until new detection data arrives for the above-described threshold comparison to be performed. If, however, the over-limit flag has been set in step 230, the process immediately branches to step 270 to carry out the transmission of the content of the data queue and reset the data transmission timer as described above. Thus, reportage of detections of over-limit signal strength is expedited relative to the normal reportage time interval and prioritized over reportage of detections of egress signals of lesser signal strength.

Referring now to FIG. 3 the process of controlling the number and frequency of notifications of a given detected over-limit egress signal. Step 310 is intended to collectively indicate all processes running or available on the central server 160. However, it should be understood that it is immaterial to the successful practice of the invention where the depicted functionalities are actually performed or between which elements they may be shared or duplicated. It is assumed that among the processes running or available on central server 160 are the work orders that have been generated but not closed. It is also assumed for purposes of this discussion that the number of notifications has been specified by a BCS administrator or set at some default value as illustrated at 305.

At some convenient time of day when processing on the central server may be relatively light or at an arbitrary designated time, the open work order database is searched for records which include an indication of a detected over-limit egress signal, as depicted at 320. The returned records are then assembled into a list or the like which may or may not be ordered by severity or some other criterion such as date and time of first detection. The list is then processed by determining if the processing of all records returned by the search have been processed as indicated at 330. While performing this determination at this point may be trivial, it is possible that no such data records have been returned by the search and to provide a convenient exit path (e.g. to step 380 when processing returned data records is complete or no such records are returned by the search). Assuming at least one record with an over-limit indication is returned by the search that record is retrieved at step 340 or if two or more records are returned, the next such record is retrieved. The notice counter value of the record is obtained from the record at 350 and compared with the previously set or default number of notifications alluded to above at step 360. If that number of notifications has not been reached, a notification is then sent to the BCS administrator 170 and any others designated to receive such notifications and the notice counter value is incremented by one and overwritten on the notice counter value in the record as depicted at 370. The process then loops back to step 330, discussed above, to process other records returned by the search, if any, and, if none, to exit at 380. As a perfecting feature of the invention not necessary to its practice in accordance with its basic principles, when the notification count equals the specified or default value, a special notification or added notice may be included to indicate that the designated or default notification count has been reached and that no further notifications will be provided.

It should also be noted in this regard, that if nominally sufficient repairs have been made and communicated to the BCS administrator 170 and thence to the central server 160, the work order will have been closed and notifications will terminate since a closed work order will not be returned by search 320. However, if an over-limit egress signal continues to be detected, it will be reported as described above, a new work order issued and the notification process repeated as discussed above. Therefore, as a further perfecting feature of the invention not necessary to its practice in accordance with its basic principles, a separate record of closed work orders for over-limit detections may be desirable for comparison with new over-limit detection reportage for causing a special notification indicating a possibly continuing or reappearance of an over-limit signal egress condition.

In view of the foregoing, it is seen that the invention provides an important tool for Broadband Communications System administrators and other responsible personnel to prioritize and expedite correction of over-limit egress signal strength from a Broadband Communications System to limit the duration of signal egress capable of interfering with free-space communications. The invention provides immediate prioritized reportage of detection of egress signal strength above a freely selectable threshold and repeated notifications at a freely selectable frequency and number of times and continued close monitoring of shielding flaws until fully effective repairs have been performed. The invention is easily and readily integrated with commonly used techniques of signal egress monitoring by mobile detectors and manual or automated dispatching of maintenance personnel and equipment.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A system for detecting and expediting reportage of detection of egress signals from a Broadband Communications System having a signal strength above a user-specified threshold, said system comprising
a mobile egress signal detector capable of capturing the time, location and egress signal strength upon detection of a potential egress signal,
a comparator for comparing said egress signal strength with said user-specified threshold,
a wireless communication link for transmitting said time, location and signal strength to a central server responsive to said comparator when said egress signal strength is greater than said user-specified threshold, and
alarm logic for transmitting a notification of an over-limit egress signal a user-specified number of times at user-specified intervals while signal egress persists unless earlier terminated.

2. The system as recited in claim 1, wherein said location is determined by a global positioning system.

3. The system as recited in claim 1, wherein said mobile signal egress detector further includes processing for digitizing said detected signal.

4. The system as recited in claim 3, further including processing for authenticating a detected signal as an egress signal.

5. The system as recited in claim 1, wherein said central server is a dedicated facility of a Broadband Communications System.

6. The system as recited in claim 1, wherein said central server is a facility providing service to a plurality of Broadband Communications Systems.

7. The system as recited in claim 1, wherein said central server includes processing for authenticating a detected signal as an egress signal.

8. The system as recited in claim 1, wherein one of said mobile detector and said central server includes processing for estimating egress signal strength at a location of a shielding flaw in said Broadband Communications System.

9. The system as recited in claim 1 wherein said alarm logic transmits said notification by e-mail.

10. The system as recited in claim 1 wherein said alarm logic transmits said notification by text messaging.

11. A method of detecting and expediting reportage of detection of egress signals from a Broadband Communications System having a signal strength above a user-specified threshold, said method comprising steps of
capturing time, location and signal strength upon detection of a potential egress signal,
comparing said signal strength with a user-specified threshold signal strength,
transmitting said time, location and signal strength to a central server when said signal strength exceeds said user-specified threshold, and
transmitting a notification of an over-limit egress signal a user-specified number of times at user-specified intervals while signal egress persists unless earlier terminated.

12. The method as recited in claim 11, wherein said location is determined by a global positioning system.

13. The method as recited in claim 11, further including processing for digitizing said detected signal.

14. The method as recited in claim 13, further including processing for authenticating a detected signal as an egress signal.

15. The method as recited in claim 11, wherein said central server is a dedicated facility of a Broadband Communications System.

16. The method as recited in claim 11, wherein said central server is a facility providing service to a plurality of Broadband Communications Systems.

17. The method as recited in claim 11, wherein said central server includes processing for authenticating a detected signal as an egress signal.

18. The method as recited in claim 11, including a further step of processing for estimating egress signal strength at a location of a shielding flaw in said Broadband Communications System.

19. The method as recited in claim 11, including a further step of
dispatching personnel and/or equipment to correct said over-limit signal egress.

20. The method as recited in claim 11 wherein said step of transmitting a notification is preformed by at least one of e-mail and text messaging.
